(19) United States
(12) Patent Application Publication
(10) Pub. No.: US 2009/0092540 A1
(43) Pub. Date: Apr. 9, 2009

(54) Method and apparatus of modifying bond angles of molecules

(75) Inventors: William Stehl, Simi Valley, CA (US); Tyson Larson, Simi Valley, CA (US)

Correspondence Address: Cislo & Thomas LLP, 1333 2nd Street, Suite #500, Santa Monica, CA, 90401-4110, US

(73) Assignee: Realm Industries

(21) Appl. No.: 11/973,170

(22) Filed: Oct. 5, 2007

(51) Int. Cl. C01B 13/00; B01J 19/08; C01B 5/00

(52) U.S. Cl. 423/580.1; 204/157.5; 422/186.04

(57) ABSTRACT

An apparatus and method for converting fluid molecules from a liquid state into a vapor state wherein the fluid has unnatural bond angles. The apparatus comprises a resistor-capacitor (RC) circuit, a chamber to contain the RC circuit and the fluid and a power source to provide power to the RC circuit. The RC circuit comprises an anode, a cathode and a plurality of substantially parallel electrically conductive plates. Current through the RC circuit generates a frequency that modifies the bond angles of molecules in a vapor state. Ignition of these molecules with unnatural bond angles reverts the molecules back to normal bond angles with a release of energy that can be utilized in many different applications without the release of toxic or noxious gases, greenhouse gases or any interaction with the atmosphere or the consumption of any atmospheric oxygen.

### TECHNICAL FIELD

This invention relates to methods and apparatus for generating an alternative and reusable fuel source.

### BACKGROUND ART

Alternative sources of fuel have been the subject of concern for many years due to the limited practical energy resources and the dangerous byproducts produced. Currently, over 70% of the energy generated comes from fossil fuels. These fossil fuels are converted to oil and natural gas. The burning of oil and natural gas leads to the production of electrical energy with carbon dioxide released as the byproduct. The production of carbon dioxide is purported to be involved in the greenhouse effect.

Many attempts have been made to harness energy from alternative sources such as wind, water, and solar. These efforts although somewhat successful, are far less efficient than the amount of energy produced by fossil fuels. In addition, nuclear energy has also been used as an alternative source of energy but the dangers of nuclear reactors have stifled its popularity.

Thus, there is a need for a safe, renewable, alternative fuel that can be quickly and easily produced and an apparatus for efficiently generating such alternative fuel that is easy to use and cost-effective.

### SUMMARY

The present invention is directed towards a method and an apparatus for changing bond angles of a molecule. The apparatus comprises a resistor-capacitor (RC) circuit to generate a resonating frequency sufficient to modify the bond angles of a molecule but insufficient to break the covalent bonds between molecules. The RC circuit comprises an anode, a cathode and a plurality of parallel electrically conductive plates separated by a narrow gap of less than 1 inch. The RC circuit is contained inside a chamber containing a fluid, such as water. A dual frequency created by the RC circuit and a power supply generates an optimal frequency conducive for modify bond angles. It is believed that modification of bond angles converts the fluid molecules into a vapor state. The vapor molecules with unnatural bond angles can be stored in a pressurized vessel for use in numerous applications.

### BRIEF DESCRIPTION OF DRAWINGS

FIG. 1 is a front view of an embodiment of the current invention showing a possible effect on the bond angles of water;

FIG. 2 is a front view of another embodiment of the current invention;

FIG. 3 is a cross-section of the embodiment shown in FIG. 2;

FIG. 4 is a perspective view of an embodiment of the electrically conductive plates;

FIG. 5 is a close up of the top view of the electrically conductive plates;

FIG. 6 is a top perspective view of an embodiment of the chamber;

FIG. 7 is a bottom perspective view of an embodiment of the chamber;

FIG. 8 is a top view of the electrically conductive plates inside the chamber;

FIG. 9 is a front perspective view of an embodiment of the current invention;

FIG. 10 is perspective view of the water manifold;

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

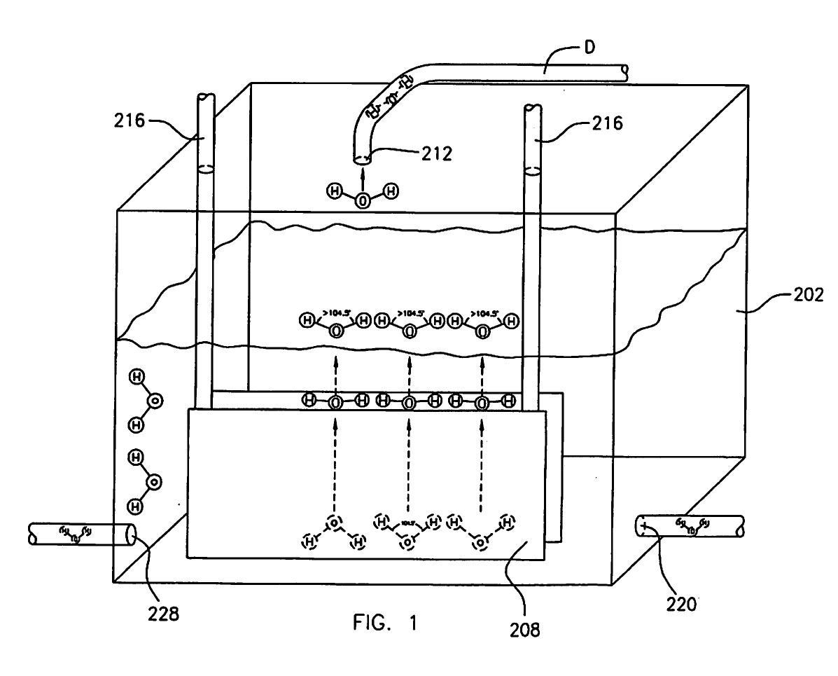

The invention is directed towards an apparatus and method for generating pressurized vapor molecules with unnatural bond angles, for example, a water molecule with a bond angle greater than approximately 104.5 degrees as shown in FIG. 1. Although the embodiments are described with water as the fluid, other fluids may be used, including fluids mixed with water and fluids that are substantially water or where water makes up the base component of the fluid. In addition, there is no requirement for the water to be purified. Without being bound by theory, the inventors believe that the conversion of a water molecule with an unnatural bond angle back to a water molecule with a natural bond angle results in the release of energy. The energy released can be used in an unlimited number of applications. In addition, the water molecules with unnatural bond angles impart improved electrical properties over water molecules with natural bond angles.

This process and resulting product have advantages over the traditional electrolysis process in that less energy is consumed in making the product and the product produced, that is water molecules with unnatural bond angles, is safer to use than the highly explosive hydrogen gas produced by electrolysis. In addition, unlike electrolysis, which requires the use of water and added electrolytes, the current method and apparatus does not require the addition of any electrolytes to the water or solution. In other words, pure water may be used.

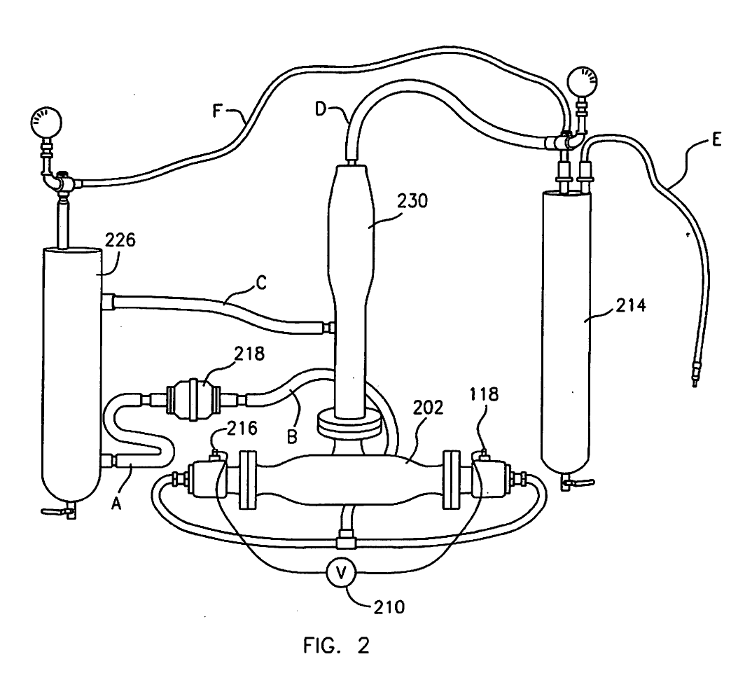

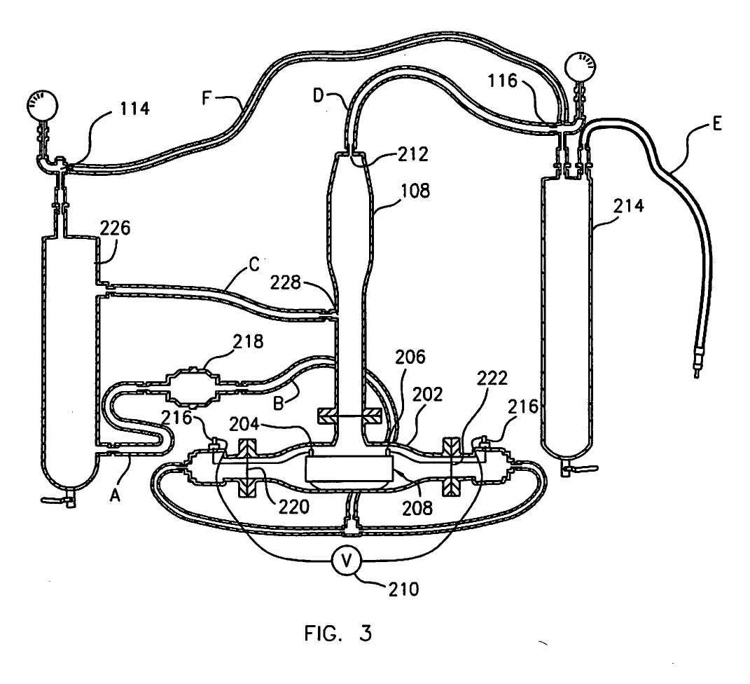

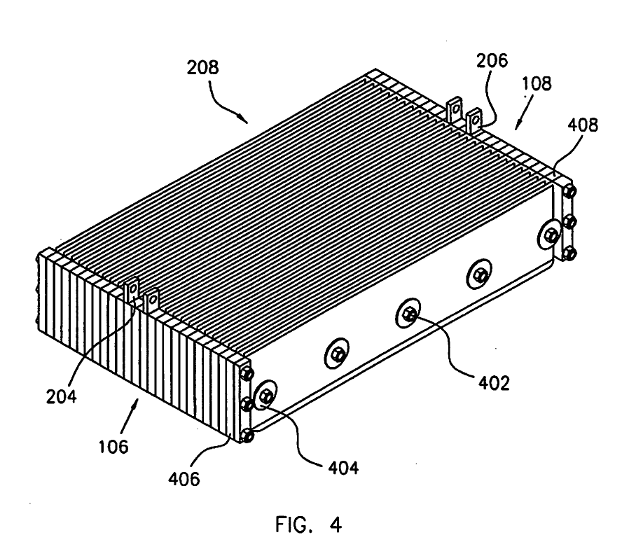

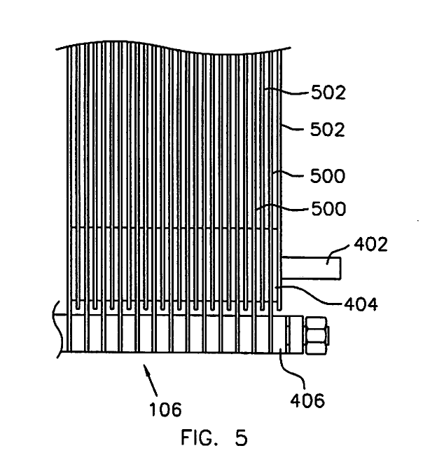

As shown in FIGS. 2 and 3, the apparatus for generating water molecules with unnatural bond angles comprises a chamber 202 containing a fluid or water, an anode 204, a cathode 206, and a plurality of electrically conductive plates 208 connected either to the anode 204 or the cathode 206; and a voltage source 210. The electrically conductive plates 208 are arranged in parallel and are alternatingly connected to the anode and the cathode such that an anode connected plate is parallel and adjacent to a cathode connected plate as shown in FIG. 4 and 5. The anode 204 is electrically connected to the positive terminal of the voltage source and the cathode 206 is electrically connected to the negative terminal of the voltage source effectively creating a resistor capacitor circuit for the generation of water vapors with unnatural bond angles.

The apparatus for generating water molecules with unnatural bond angles further comprises a water vapor outlet 212 to allow the water vapor molecules to escape and a pressure vessel 214 connected to the water vapor outlet 212 to contain the escaped water molecules with unnatural bond angles. Without being bound by theory, the inventors believe that applying a predetermined amount of power to the electrically conductive plates 208 creates agitation and modification of bond angles of the water molecules on the surface of the plates without breaking covalent bonds. The agitation and modification of bonds into unnatural angles disrupts the non-covalent interactions of water molecules with each other, resulting in water vapors. The water vapors escape from the liquid water, thereby increasing the pressure within the vessel. The pressure build-up further facilitates maintaining water molecules with unnatural bond angles in a vapor state. Ignition of this water vapor causes the bond angles to return to their natural state and release energy.

The current applied to the anode 204, cathode 206, and electrically conductive plates 208 causes the water molecules to have a weak dielectric constant, which effectively generates a resistor-capacitor (RC) circuit, with a fixed capacitor in parallel with a variable resistor, generating an oscillating or resonating frequency. The resonating frequency may be calculated as the inverse of the product of the resistance and the capacitance. The resistance changes as a function of the purity of the fluid, the changes in electrical resistivity based upon the nature of the impurities in the fluid, the amount of the gas entrained in the fluid, the rate of circulation of the fluid, the surface tension of the fluid, the pressure in the vessel, the amount of vapor produced and the temperature of the water. The capacitance is a function of the applied current, the surface area of the electrically conductive plates 208 and number of electrically conductive plates 208, and the gap between plates 208. It is believed the resonating frequency in combination with the intrinsic or inherent frequency generated by the power source 210, which has a different frequency, amplitude, and cycle than the resonating frequency, results in an optimal modified frequency, referred to as the modifying frequency, that facilitates the agitation and modification of bond angles without breaking covalent bonds, resulting in water vapors with unnatural bond angles. In addition, the water vapor with unnatural bond angles adopts an electrical property and a magnetic property that can be utilized in a variety of applications. This is distinguishable from the electrolysis process in which covalent bonds are broken and diatomic hydrogen and oxygen gases are generated without any electrical or magnetic properties. In addition, electrolysis requires higher levels of energy since breaking of covalent bonds is required as opposed to modification of bond angles.

A computer may be implemented to automatically calculate the proper parameters necessary to generate a predetermined optimal frequency based upon feedback received from the operating unit.

For reasons not completely understood, this dual frequency stimulation results in better performance, or better production of water vapors with unnatural bond angles, than a single frequency stimulus that is equivalent to the sum of the dual frequency stimulation. It is theorized that one frequency delivers the necessary power characteristics to the fluid while the compounded frequency delivers the vibratory energy necessary to the modification of the bonding angle. In addition, the dual frequency stimulation provides for broader range of frequencies than a single frequency stimulus. It is theorized that the use of multiple frequencies, that is, more than two frequencies, may improve the efficiency of the apparatus. The resonating frequency may be approximately 50 Hz to approximately 40 KHz. Preferably the resonating frequency is approximately 1 KHz to approximately 22 KHz.

Unlike electrolysis, which requires direct current, the current invention may use alternating current or direct current. Therefore, electricity from a standard outlet can be used to power the apparatus.

The current may be supplied by any power source 210 of approximately 1 volt to approximately 500 volts. Preferably the power source 210 is from approximately 2 volts to approximately 24 volts. The preferred amount of current utilized is a function of the surface area of the plates 208 and the distance between the plates and the varying resistance of the substance between plates. The voltage and current can be adjusted to produce approximately 1 watt per square feet of surface area to approximately 100 watts per square feet of surface area. Adjustment beyond this level is possible should it be required for efficient operation of the apparatus.

In one embodiment, the current is continuously applied to the plates 208. In another embodiment, the current can be applied with a duty cycle of approximately 0.005 to 0.5 (or 0.5% to approximately 50%). For example, the current can be on for 2 milliseconds then off for 98 milliseconds. The predetermined duty cycle may be generated by using a MOSFET array or SCR networks. The duty cycle may be modified by a computer in real time based upon feedback received from the apparatus. In one embodiment, the MOSFET array is powered by DC supply. In a preferred embodiment, the MOSFET array is powered by a battery.

In some embodiments, a power pass through 216 connects the voltage source 210 with the anode 204 and the cathode 206 to supply current to the anode plate and the cathode plate at the anode terminal and cathode terminal, respectively. In one embodiment, two anode terminals and two cathode terminals are used to provide structural stability for the plates. The two anode terminals and the two cathode terminals can be secured through their respective power pass throughs 216.

In some embodiments, the anode 204 and the cathode 206 are plates, each comprising a surface. The anode plate surface and the cathode plate surface may be opposite and parallel to each other. The plurality of electrically conductive plates 208 can be positioned perpendicular to and in between the anode plate and the cathode plate. The electrically conductive plates 208 can be arranged parallel to each other in an alternating arrangement such that a first electrically conductive plate connected to the anode is parallel and adjacent to a second electrically conducive plate connected to the cathode. In other words, a first set of electrically conductive plates 500 may be attached perpendicular to the anode plate with the surface of each electrically conductive plate aligned parallel to each other, thereby creating a plurality of parallel anode plates. A second set of electrically conductive plates 502 may be attached perpendicular to the cathode plate with the surface of each electrically conductive plate aligned parallel with each other, thereby creating a plurality of parallel cathode plates. The plurality of parallel anode plates and the plurality of parallel cathode plates can then be aligned parallel with each other such that the electrically conductive plates from the first and second set are aligned adjacent to each other in alternating fashion as shown in FIGS. 4 and 5. A non-conductive rod 402 can be inserted through the first and second set 500, 502 of electrically conductive plates so as to provide structural stability. Each electrically conductive plate can be separated from the other by a non-conductive washer 404.

The anode plate and the cathode plate may each comprise a plurality of plate holes. Screws or bolts can be inserted into the plate holes to fasten an electrically conductive plate.

In some embodiments each electrically conductive plate has a right angle bend and a plurality of fastener holes to provide a means for attaching the first and second set 500, 502 of electrically conductive plates to the anode 204 or cathode 206, which are parallel to each other, while maintaining a parallel alignment among the electrically conductive plates. Each fastener hole can be aligned with a corresponding hole on the anode or cathode plate.

In another embodiment, the anode plate and the cathode plate may be replaced by a plurality of anode power blocks 406 and cathode power blocks 408. Each electrically conductive plate 208 from the first set 500 of electrically conductive plates may be sandwiched in between each anode power block 406 and each electrically conductive plate 208 of the second set 502 of electrically conductive plates may be sandwiched in between each cathode power block 408 as a means for fastening or securing the electrically conductive plates parallel to each other. The power blocks 406, 408 and electrically conductive plates 208 can be further secured with a rod 402 that passes through each electrically conductive plate 208 and each power block.

The anode 204, the cathode 206, and the plurality of electrically conductive plates 208 can be made of any conductive material such as copper, aluminum, platinum, silver and other metals and metal alloys. Metals that are sturdy and non-corrosive are preferred, such as stainless steel. Other embodiments could utilize flexible electrical conductive materials in irregular shapes with structural integrity and anode/cathode spacing maintained by an appropriate exoskeletal structure or support. Such an embodiment would enable the apparatus to fit into irregular shaped spaces as may be required by some applications. In one embodiment, the electrically conductive plates 208 are sandblasted or sanded to create miniature pits, crevices, points, or edges, thereby increasing the surface area of the electrically conductive plates and enhancing the transfer of energy into the fluid.

The electrically conductive plates 208 can take on an unlimited number of shapes, sizes, and dimensions, constrained only by spacing issues, arrangement, and surface area. In a preferred embodiment, the electrically conductive plates 208 should be parallel to each other. This maximizes the potential number and size of plates that can be placed inside a chamber. In one embodiment, a chamber 202 contained twenty parallel plates 208 having a length of 1 foot and a height of 0.5 foot. In another embodiment, a chamber 202 contained twenty parallel plates 208 having a length of 4 feet and a height of 0.5 foot.

The gap between each adjacent plate 208 can be from approximately 0.05 inch to approximately 1 inch. Preferably each adjacent plate 208 has a gap of approximately less than 0.25 inch. In one embodiment, the gap between adjacent plates 208 is approximately 0.125 inch.

The parallel arrangement also facilitates movement of water in between the electrically conductive plates 208. The movement of water allows water to pass across the surface areas of the electrically conductive plates 208 in between the gap between the electrically conductive plates 208, thereby dislodging the water vapors forming on the electrically conductive plates 208 from the plates causing the water vapor to rise to the surface of the water and escape from the liquid water. In some embodiments, the electrically conductive plates 208 can be a series of cylinders or cones of decreasing size, concentrically arranged one inside another, with open ends. The open ends can be aligned with the direction of the movement of water.

In some embodiments, movement of water can be created by vibrating, rocking, tilting, shaking or otherwise agitating the chamber 202. For example, the chamber 202 may be placed on a rocking or tilting machine. In some embodiments, a chamber 202 may be placed inside a vehicle so as to encounter natural agitation of the water due to vibrations, bumps, turns, acceleration and deceleration of the vehicle. In other embodiments, movement of water is generated by creating a flow of water, for example, with a water pump 110. In some embodiments, one or more ultrasonic transducers could be placed in or upon the chamber 202, the effect of which would be to detach the bubbles of vapor as they are formed.

The chamber 202 may further comprise a water inlet orifice 220. The water inlet orifice 220 may be positioned anywhere on the chamber to generate a continuous flow of water. As shown in FIGS. 2 and 3, to maximize the flow across the electrically conductive plates, the water inlet orifice 220 may be placed adjacent and perpendicular to the electrically conductive plates 208 such that water flowing in through the water inlet orifice 220 will flow parallel with the electrically conductive plates 208 through the gaps. In some embodiment, the chamber 202 may have a second water inlet orifice 222 opposite the first water inlet orifice 220. Water can flow through the first water inlet orifice 220 in a first direction parallel with the electrically conductive plates 208 through the gap at one end of the chamber while also flowing through the second water inlet orifice 222 in a second direction, opposite the first direction, from the other end of the chamber, parallel to the electrically conductive plates 208 into the gaps. Water flowing through the electrically conductive plates 208 from two opposite ends will maximize the water movement at the ends and the middle of the electrically conductive plates, thereby increasing the efficiency of water vapor production. A branching water pipe may be used to supply water simultaneously through the first water inlet orifice 220 in a first direction and through the second water inlet orifice 222 in a second direction, opposite the first direction.

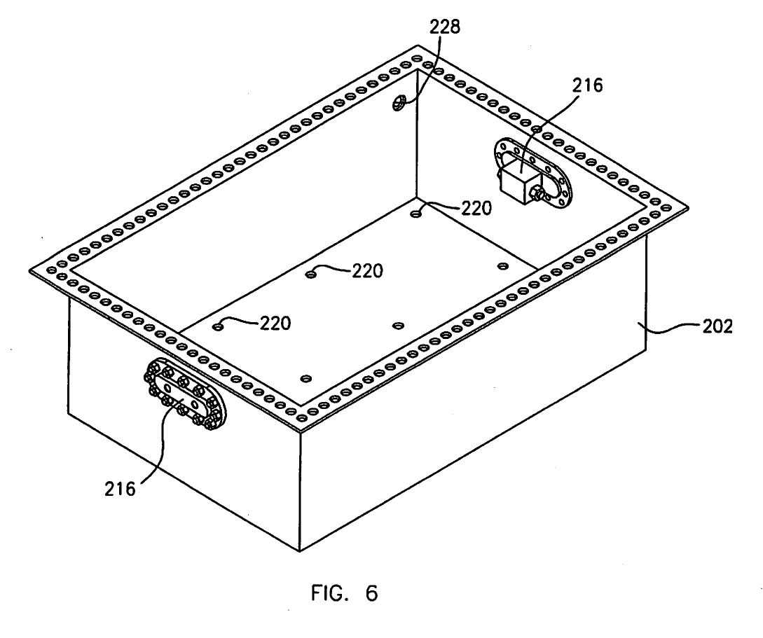

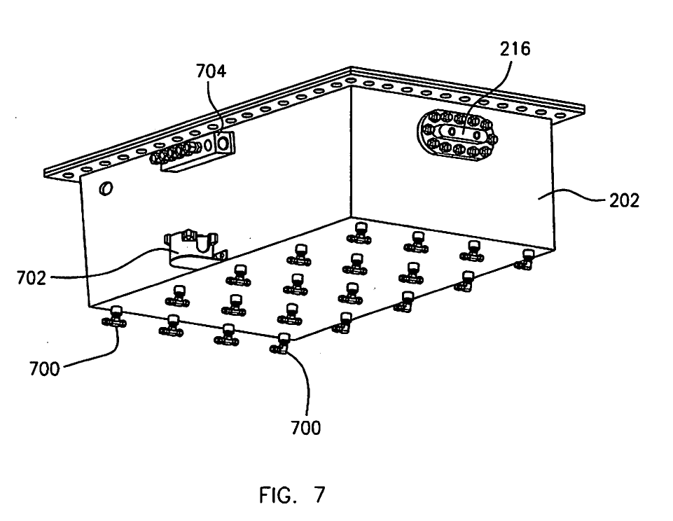

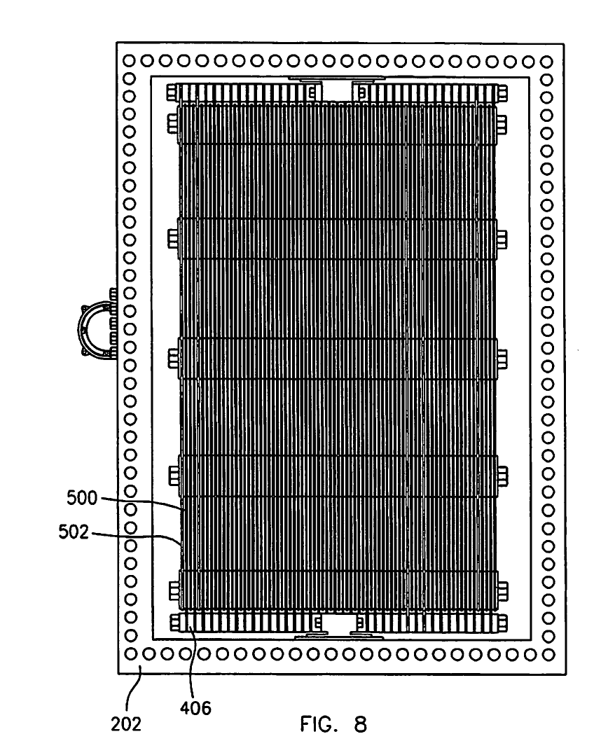

In another embodiment, a water inlet orifice 220 may be positioned at the bottom of the chamber, below the electrically conductive plates, with the water flow projecting upwards into the gaps, parallel to the electrically conductive plates as shown in FIGS. 6-8. A plurality of water inlet orifices 220 can be positioned at the bottom of the chamber, below the electrically conductive plates 208 to ensure sufficient water movement across all surfaces. Each water inlet orifice 220 may be equipped with nozzles 700 to help secure tubing.

A water pump 110 may be used to force the flow of water from an external water supply 226 into the chamber through the water inlet orifice 220. In some embodiments, a pump base 702 may be attached near or to the chamber 202 to support the water pump 110. In one embodiment, the water pump 110 draws water from the external water supply 226 through tube A and forces the water into the chamber 202 via tube B.

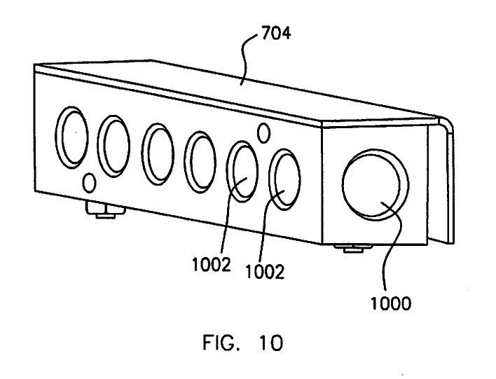

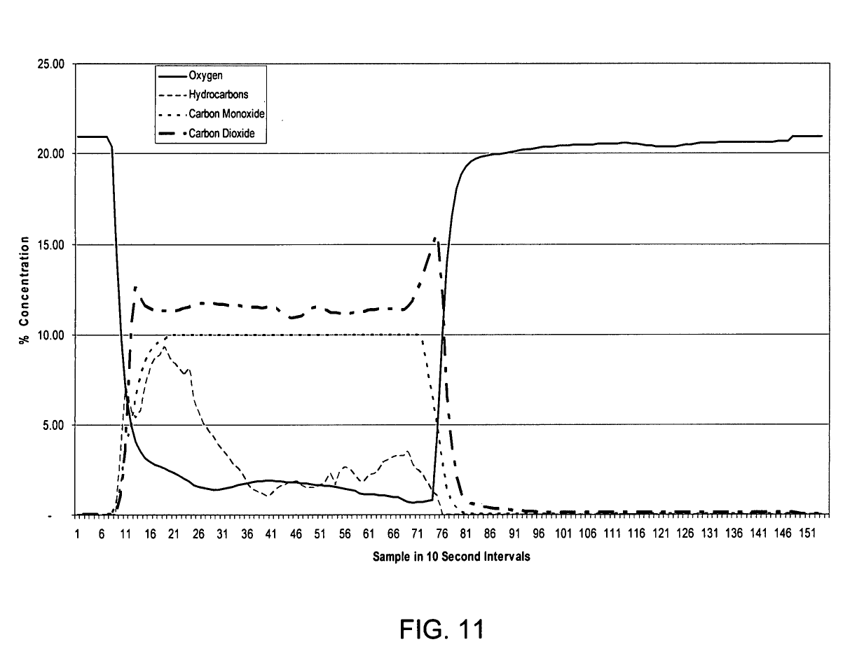

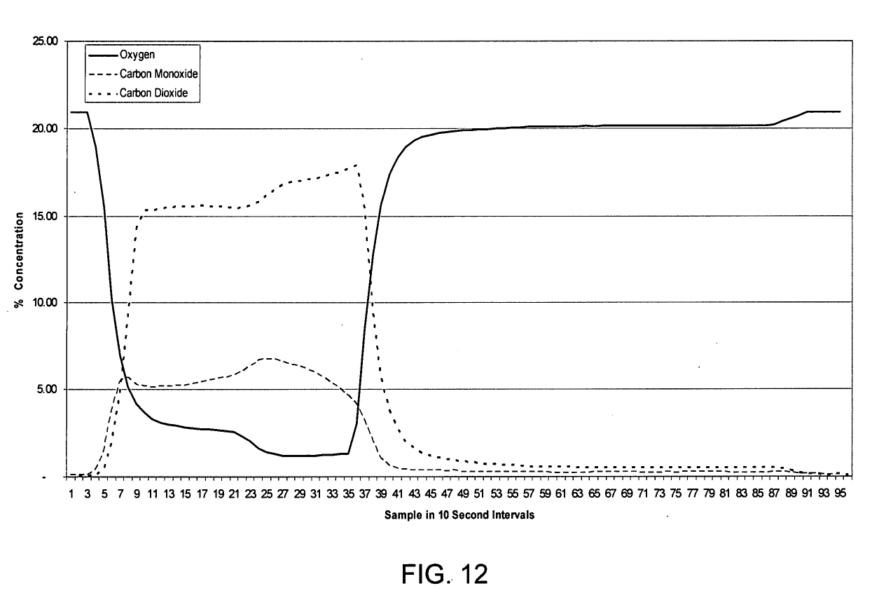

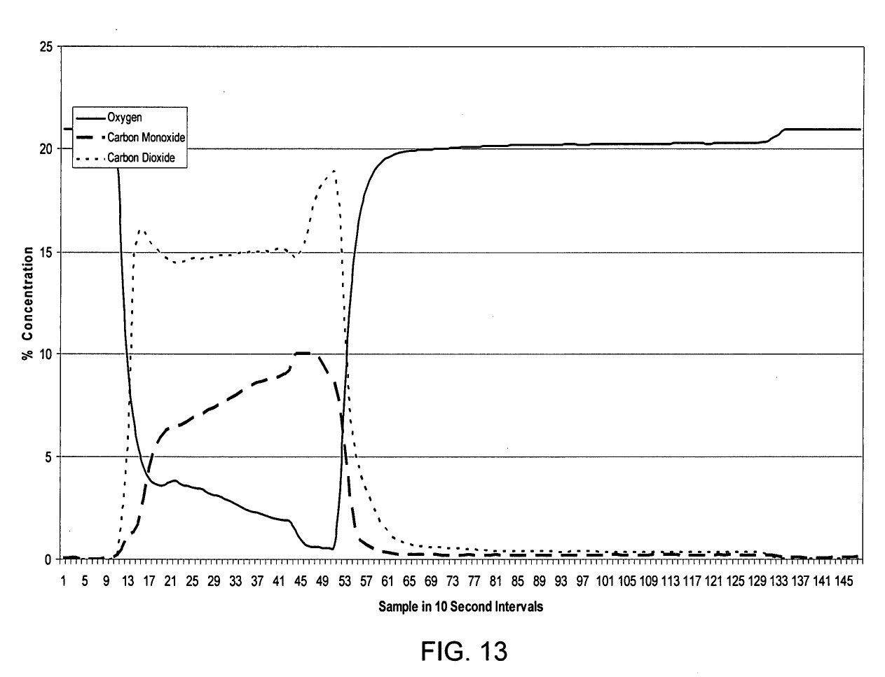

In embodiments with a plurality of water inlet orifices 220, a water manifold 704 may be attached near or to the chamber 202. As shown in FIG. 10, the water manifold 702 may comprise at least one entry hole 1000 and a plurality of exit holes 1002. The entry hole 1000 is attached to the water pump 110 to receive water flow. The plurality of exit holes 1002 are connected to tubes that feed back into the water inlet orifices 220 through the nozzles 700 to recycle the water back into the chamber 202.

In embodiments where water is forced through the chamber 202, the chamber 202 may further comprise a water outlet orifice 228. The water outlet orifice 228 can lead back to the water supply 226 via tube C, thereby allowing the water that was not converted into vapors to be recycled. Therefore, water can be added to the chamber 202 to a desired level. When the water pump 110 is turned on water is force into the water manifold 704 where the water splits into a plurality of tubes connected to the plurality of water inlet orifices 220, thereby forcing water into the chamber 202. In embodiments without a water manifold 704, the water pump 110 pumps the water directly to the water inlet orifice 220. From the chamber 202 the water is forced out the water outlet orifice 228 back into the water pump 226, thereby forming a closed loop.

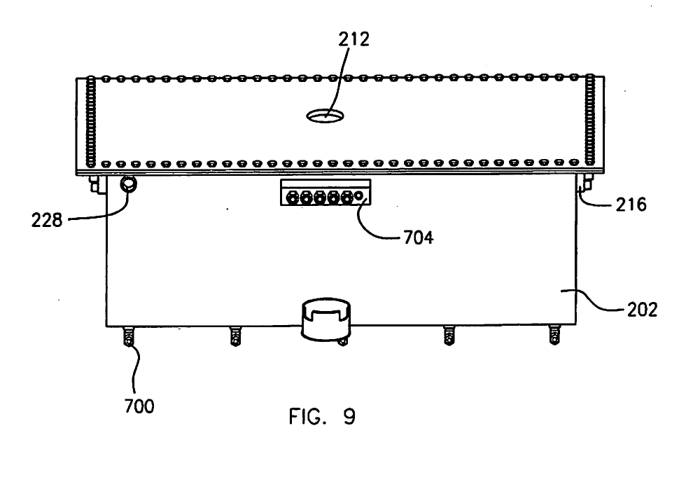

As shown in FIGS. 3 and 9, the water vapor outlet 212 may be located above the electrically conductive plates. Preferably, the water vapor outlet 212 is located close to the electrically conductive plates 208 so that the water vapors are not required to traverse relatively large distances through the liquid water to escape into the space. In some embodiments, the water vapor outlet 212 connects to the pressure vessel 214 via a tube D. Tube E is also attached to tank 214 to ensure that any gas trapped in the water supply 226 is allowed to escape to pressure vessel 214 for use.

The amount and nature of current passed across the electrically charged plates is sufficient to agitate and modify chemical bonds of water molecules into unnatural bond angles but insufficient to break the covalent oxygen-hydrogen bonds. Nonetheless, due to the agitation and modification of bond angles of water molecules, the non-covalent bonding interactions between adjacent water molecules is disrupted and water across the surface of the electrically conductive plates convert into water vapors. The water flow across the surface of the plates facilitates the escape of water vapors created on the surface of the electrically conductive plates into the air. The creation of water vapors increases pressure in the chamber and generates a pressurized water vapor molecule with unnatural bond angles. The pressure build up helps maintain water molecules with unnatural bond angles.

The amount of water inside the chamber should be sufficient to completely immerse the electrically conductive plates 208. In one embodiment, the chamber is large enough such that even when the electrically conductive plates are completely submerged, a space exists above the water for the water vapors to escape into. A water vapor outlet orifice 212 can be positioned along the top of the chamber 202 leading to a pressure vessel 112. In embodiments with a water outlet orifice 228, the water outlet orifice 228 may be positioned along the chamber 202 such that the water level remains below the water vapor outlet 212. The water flow rate into the chamber should be approximately equal to the water flow rate out of the chamber so as to maintain a constant water level to keep the electrically conductive plates 208 submerged and to prevent water from entering into the water vapor outlet 212.

In another embodiment, a water vapor trap 108 is located above the water. The water vapor trap 108 may have a wide base to increase the area which the water vapor can escape into. The water vapor trap 108 may taper towards the top to funnel the water vapor in a desired direction. In embodiments with a water vapor trap 108, the water vapor outlet 212 can be positioned on the water vapor trap 108. In addition, the water vapor trap 108 may further comprise the water outlet orifice 228 to direct the water back to the water supply for recirculation. In another embodiment, the water vapor trap 108 can simply be the area above the level of the water.

The chamber 202 is connected to a pressure vessel 214 via the water vapor outlet 212. As the pressure builds up inside the chamber 202, the pressurized water vapor molecules are forced through the water vapor outlet 212 into the pressure vessel 214. The pressure vessel 214 may comprise a pressure gauge to determine the amount of pressure build up. The preferred amount of pressure to maintain water molecules with unnatural bond angles is approximately 1 pound per square inch (psi) to approximately 100 psi. However a higher pressure could be used for certain compressed gas applications. Contained at this pressure, the water molecule can maintain an unnatural bond angle for several months depending on the quality of the pressure vessel. The water molecules with unnatural bond angles can be released, for example, tube F for use in a variety of applications.

Due to the pressure build-up the chamber 202, pressure vessel 214, water trap 108, and water supply tank 104 should be made of material sturdy enough to maintain structural stability at high pressures. In addition, the material used may be non-corrosive such as metal, acrylic, PVC, plastic and the like. Preferably, the chamber 202 is made of stainless steel.

A non-conductive, non-water permeable coating may also be used to coat the inner surface of a metal chamber to increase the efficiency of energy production. A metal chamber may decrease the efficiency of water vapor production by shunting some of the electricity to ground. By coating the inner surface of a metal chamber with a non-conductive material, the electricity generated will remain in the electrically conductive plates. Suitable coatings include acrylic and fiber glass. A coating may be applied to the surface by, for example, sandblasting.

The apparatus may comprise a single chamber or a plurality of chambers. In embodiments with a plurality of chambers, each chamber would require the parts associated with the chamber. To share the water supply, maximize space, and increase efficiency, the chambers can be arranged in parallel. The power source can be attached to the plates of the different chambers in series or parallel as may suit the application. In addition, the water supply can flow into the chamber in parallel. This will allow the apparatus to share the same power source and water supply. A merging tube can be connected to each water outlet orifice and merge the water into a single vapor trap. The vapor trap can comprise its own water outlet orifice to recycle the water back into the water supply. The water vapors can also merge and collect in the water vapor trap and be forced through the water vapor outlet into a pressure vessel. This allows the water vapors generated in each chamber to combine together in a single pressure vessel.

It is believed that a water molecule with an unnatural bond angle can be created by exposing the water molecule to electromagnetic radiation of a wavelength greater than 0.1 cm and less than 100 cm. Preferably the electromagnetic radiation has a wavelength in the range of approximately 0.1 cm to approximately 100 cm. More preferably, the electromagnetic radiation has a wavelength of approximately 1 cm to 50 cm. In another embodiment, the electromagnetic frequency is between approximately 0 to approximately 5 gigahertz (GHz). In one embodiment, the electromagnetic frequency is approximately 1.1 GHz. In another embodiment, the electromagnetic frequency is approximately 2.2 GHz.

The electromagnetic radiation is applied through current. In one embodiment, the electromagnetic radiation may be applied as pulse width modulated direct current of unequal pulse spacing and reduced duty cycles. Therefore, although these ranges of wavelengths encompass microwaves, the mechanism of action differs from that of microwaves being applied with alternating currents as in the conventional microwave oven.

This invention is also directed towards a method of modifying a bond angle of a molecule, for example, generating a water molecule with an unnatural bond angle, comprising providing a first frequency; providing a second frequency different from the first frequency; generating a modifying frequency by combining or summating the first frequency and the second frequency; and exposing the molecule to the modifying frequency to create the unnatural bond angle without breaking the covalent bond.

The first frequency may be the intrinsic or inherent frequency generated by a power source. The second frequency may be the resonating frequency generated from the plurality of electrically conductive plates. The resonating frequency is approximately 50 Hz to approximately 40 KHz. In some embodiments, the resonating frequency is approximately 1 KHz to approximately 22 KHz.

Each electrically conductive plate comprises a surface area and is arranged parallel to each other. The power source and the electrically conductive plates effectively create a resistor-capacitor circuit. The current from the power source may be applied with a duty cycle of approximately 0.005 to approximately 0.5. The amount of power applied to the plurality of electrically conductive plates may range from approximately 10 watts per square feet of surface area to approximately 100 watts per square feet of surface area. In some embodiments, the power applied to the plurality of electrically conductive plates is approximately 30 watts per square feet of surface area to approximately 50 watts per square feet of surface area.

The method of generating a molecule, such as a water molecule, with an unnatural bond angle further comprises pressurizing the molecule with the unnatural bond angle to maintain the unnatural bond angle and containing the pressurized molecule with an unnatural bond angle in a pressure vessel.

Although this invention was described with respect to water as the molecule with an unnatural bond angle, the apparatus and methods described herein may be applied to other aqueous and non-aqueous solutions whose electromagnetic properties are conducive to similar processing. As such, this invention is also directed towards a molecule comprising an unnatural bond angle. Preferably, the molecule comprising an unnatural bond angle is pressurized. The unnatural bond angle is any bond angle other than a characteristic bond angle of a molecule in its natural state. For example, the bond angle of water in its natural state is approximately 104.5 degrees. Therefore, a water molecule with an unnatural bond angle is one a bond angle other than 104.5 degrees. For example, the bond angle may be greater than approximately 104.5 degrees. In some embodiments, the bond angle may be greater than approximately 109 degrees. In some embodiments, the bond angle may be 180 degrees.

It is believed that the reversion of a molecule with an unnatural bond angle back to its natural state with natural bond angles results in the release of energy. As such, numerous applications have been contemplated as listed below. One example is that a molecule with an unnatural bond angle may be used as an alternative fuel source. This can be accomplished by providing a molecule with an unnatural bond angle in a pressurized vessel at a pressure of approximately 1 psi to approximately 100 psi, then releasing the molecule with the unnatural bond angle from the pressurized vessel, and igniting the molecule with the unnatural bond angle with an electrical discharge. For example, a high frequency, high voltage ignition source such as a spark plug may be utilized. The ignition of the molecule with the unnatural bond angle reverts the unnatural bond angle back to a natural bond angle state and releases energy. Energy is released as sonic energy, mechanical energy, heat and chemical energy. In some embodiments, the energy released may be useable as an alternative fuel. The alternative fuel may be used as a replacement for gasoline for powering a motorized device, such as an automobile. In some embodiments, the energy released may be used to maintain a flame or fire.

### EXAMPLES

Water vapors with unnatural bond angles were generated and captured in a pressure vessel at 35 psi by applying 5 volts to a generator comprising four parallel chambers with 20 plates in each unit; each plate having a surface area of 4 square feet and arranged parallel to each other with a gap of 0.1765 inches between plates. The pressurized vapor was regulated down to 5 psi and released through a cutting torch tip of the size #00 and ignited effectively creating a blowtorch, cutting torch, or welding torch. The flame generated was used to cut through many different materials including thin sheets of titanium and nickel plated steel. Also a tungsten welding rod was used as a sample metal and was melted by the cutting torch using water vapor with unnatural bond angles.

Water vapors with unnatural bond angles were generated and captured in a pressure vessel at 35 psi by applying 5 volts to a generator comprising four parallel chambers with 20 plates in each unit; each plate having a surface area of 4 square feet and arranged parallel to each other with a gap of 0.1765 inches between plates. The pressurized vapor was regulated down to 6 psi and injected into the intakes of two different types of single cylinder internal combustion engines. The two types of engines were a gasoline engine, a Honda GX 340, and a tri-fuel engine, a Honda GX 390. The modifications to the engines that allowed the insertion of the water vapor with unnatural bond angles was the removal of the carburetor and an insertion plate on the intake to allow only the water vapor with unnatural bond angles and not outside air to enter. This modification allowed these engines to start and run without any outside air or extra fuel other than the modified water vapor.

As summarized in FIG. 11, the pressurized vapor was also used to run an automobile with significantly reduced toxic byproducts. A Toyota FJ-40 with a 2-F straight six cylinder engine was modified such that the pressurized water vapor with unnatural bond angles was inserted below the carburetor in an extra port in the manifold intake using a ball valve as a shutoff and an automobile quick connect. Also a shutoff was installed in the engines normal gasoline line to allow a complete interruption of gasoline from the gas tank to the engine's carburetor. The engine was started and regular unleaded car gasoline was used to keep the motor running. The levels of gases emitted from the tailpipe were measured in 10 second intervals by the IMR 2800A Exhaust Gas Analyzer and the results are shown in FIG. 11. Data points 1 through 71 indicate conditions when regular unleaded gasoline was used. Oxygen levels in the air were above 20% before ignition and dropped to less than 5% within 3 minutes. Levels of hydrocarbons, carbon monoxide, and carbon dioxide where virtually undetectable before ignition and rose to approximately 10% or more. After approximately 12 minutes, the fuel source was switched from the unleaded gas to the vapor described as this invention (see Data points 72-78 in FIG. 11). Approximately 1 minute after switching to the vapor, the engine was running on pure vapors (data points 79-147 in FIG. 11). As shown, oxygen levels in the air had return to normal at above 20% and hydrocarbon, carbon monoxide, and carbon dioxide levels returned back to undetectable levels. The engine, however, was still running. After an additional 11 minutes, the engine was turned off (data points 148 to 154) and the levels of oxygen, hydrocarbons, carbon monoxide, and carbon dioxide remained unchanged compared to levels when the engine was running on the vapors.

This experiment was repeated two more times and the results have been reproduced in FIGS. 12 and 13 with similar results. As shown in FIG. 12, when the engine was turned on using unleaded gasoline oxygen levels in the air dropped from above 20% to below 5% (data points 1-35) and toxic gas levels rose from undetectable levels to over 5% (carbon monoxide) and 15% (carbon dioxide). When the fuel was switched from unleaded gasoline to the vapor, oxygen levels rose back to approximately 20% while toxic gas levels dropped back to below 1% (data points 43-87). When the engine was turned off, oxygen levels remained unchanged and toxic gas levels decreased to undetectable levels.

FIG. 13 shows the third experiment with oxygen levels dropping from above 20% when the engine was off to below 5% when the engine was turned on using unleaded gasoline. Carbon monoxide and carbon dioxide rose from undetectable levels when the engine was off to levels exceeding 5% and 15%, respectively, when the engine was running on unleaded gasoline (data points 1-36 in FIG. 13). After the fuel was switched from unleaded gasoline to the vapor described herein, the levels of oxygen rose back up to approximately 20% and the toxic gases dropped to undetectable levels (data points 51-129 in FIG. 13). After the engine was turned off gas levels were unchanged compared to when the engine was running on the vapor (data points 130-150 in FIG. 13).

Applications

Numerous applications have been contemplated by the inventors. The following is not an exhaustive list of possible applications but rather a few examples in various fields to provide a sample of the potential uses.

Water

Water Treatment Systems for Culinary/Commercial Uses—Saline/Brackish

Water for Injectables—Medical

Semi-conductor Manufacturing Water

Reclamation of Useful or Valuable Substances from Water

Mine Waste Water Treatment

Food Product Water

Reclamation of Industrial Waste Water and Contents

Reclamation of Grey Water for Agriculture, Recreation

Energy (Electrical)

Air Quality Improvement for Existing Facilities by Pollutant Capture Including Coal

Reduce/Eliminate Hydrocarbon Fuel Requirements

Reduce/Eliminate Greenhouse Gas Emissions

Utilize Water/Gravity Systems in Electrical Energy Production

Utilize Charged Gas Systems in Electrical Energy Production

Bring Shut-in Plants On-Line—Can Meet Air Quality Requirements

Personal Transportation

Retrofit Existing Internal Combustion Engines for New Fuel

Retrofit Existing Internal Combustion Engines to Capture Carbon Based Emissions

Retrofit to Eliminate Nitric Oxide, Sulfur Dioxide, Particulate Emissions

New Engine Designs to Optimize Use of New Fuel

Internal and External Combustion Engines

Mass Transportation

Retrofit Buses etc. to Reduce Hydrocarbon Use and Emissions

Retrofit Trains to Reduce Hydrocarbon and Emissions

New Engines to Optimize Environmental, Efficiency, Safety for both Internal and External Combustion Engines

Commercial Transportation

Retrofit Over the Road Trucks Reduce Hydrocarbon Use

Reduce Emissions, Noise

New Internal and External Combustion Engines

Harvest, Store, Distribute Excess Energy

Maritime

Retrofit Marine Engines to reduce Hydrocarbon Use and Emissions

Reduce Emissions While in Port Areas

Provide Fresh Water for On-board Use

Reduce Need to Carry Ice to Cool Fish Cargo

Increase Effective Time at Sea

Reduce Cost, Hydrocarbon, Emissions for On-Board Generation of Ship's Power

Reduce Pollution at Sea from Hydrocarbon Use, Cargo

Increase Effective Range

Increase Effective Cargo Capacity

“Pull Push” Propeller Free Low Draft Propulsion and Maneuvering System

Energy (Hydrocarbon)

Capture and Utilize Emissions from Coal Powered Plants Eliminating CO₂

Reduce/Eliminate Use of Fuel Oil and Natural Gas Eliminating CO₂

Enable Hydrocarbon Production from Oil Shales and Sands

Utilize Excess Hydrocarbons in Production of Plastics, Pharmaceuticals, Chemicals, etc.

Energy (Nuclear)

Replacement of Nuclear Fuel Rods in Existing Reactors Reduction of Nuclear Waste Materials Treatment of Reactor Cooling Water

Chemistry

High Purity Gases

Inorganic/Organic Chemical Synthesis

High Temperature Chemistry in Vacuum Over Long Periods

Reductive Purification of Metals (Aluminum, etc.) without Carbon

Multi-Frequency Redox Reaction Chemistry in Vacuum or Atmosphere

Chemical Reactions in Extreme Conditions

Physics

Sustained Plasma Reactions in Vacuum and Near Vacuum Conditions

Reactions in Electron Rich Conditions—Heat—Vacuum

Spectroscopy

Time/Space Continuum Phenomenon

Ion/Plasma Propulsion Systems for Deep Space

Real Time Elemental Analysis

Materials Testing

High Temperature Synthetic Crystal Growth

Metallurgical

High Temperature Assaying and Testing

High Temperature Production and Refining in Vacuum

Reduction of Carbon Emissions from Heating Operations

Elimination of Storage of Dangerous Gases

Electrical Energy Reduction

Real Time Monitoring and Control of Pyrometallurgical Processes

High Temperature Operations Without Electrical and Magnetic Field Generation

Heat, Cooling, Refrigeration

Residential and Commercial Heating—Reduction/Elimination Carbon Fuels

Air Conditioning

Large Scale Refrigeration

Reduced Electrical Consumption

Air Quality Maintenance

Public Safety

Aircraft Oxygen Systems

Firefighter Breathing Apparatus

Portable Oxygen Apparatus

Non-destructive Stun Grenade

Fire Control/Extinguishment

Precision Metal Cutting Apparatus, Small, Portable, Quick

Decontamination, Detoxification Systems

Large Scale Anti-bacterial Systems

Crowd Control

Recreation

Tankless Underwater Breathing Apparatus

Special Effects

Personal Watercraft/ATV Propulsion

Lighter than Air Craft

Small Scale Water, Electrical, Waste Systems for Recreational Use

Military (Defensive Only)

“Caterpillar Drive” for Submarine Use

Water Thrust Surface Propulsion System

Remote Observation Propulsion

Lighter than Air Craft

Mine Clearance

Disorientation Devices

Tunnel and Bunker Destruction

Covert Naval Vessel Destruction

Extra-atmospheric Power, Water, Light, Oxygen, Propulsion Systems from Water or Ice

Rocket Fuel—Non-explosive

Vehicle Fuel—Non-combustive

Hydrocarbon Free Torpedo Propulsion

Reduces Fuel Transportation, Delivery Hazards and Time

Food Processing

Reduction/Elimination of Harmful Organisms through Cell Membrane Rupture

Container Size Flash Freezing/Refrigeration

Large Scale Anti-Bacterial Systems Vacuum Packaging systems

Industrial

Welding and Cutting Like and Unlike Materials

Vibration and Shock Testing

Sustained Heat in Vacuum

Vacuum Based Burn-in Systems

Simplified Liquid Pumping Systems Over Long Distances

Large Scale Vacuum Pumps

Environmental

Reclamation of Atmospheric Pollutants for Product Synthesis

Reduction of Carbon Footprints Across the Board

Creation of Carbon Credits to Fund Environmental Programs

Reduce Destruction of Environment by Carbon Based Pollutants

Reduce Need to Harvest Trees, Burn Rain Forest

Atmospheric Oxygen Enrichment

Agricultural

Atmospheric Nitrogen Fixation

Low Cost Pumping Systems with Reduced Moving Parts

On-site Fertilizer Production

Food/Feed Preservation

Pest Control

Reduce/Eliminate Hydrocarbon Fuel Use—Carbon Emissions

Reclamation of Soil Fouled by Irrigation Residue

Reclamation—Recycling of Fertilizer from Irrigation Run-off Water

Waste Management

Human Waste Management

Industrial Waste Management

Medical Waste Management

Toxic Waste Management

Sewage Treatment

Large Scale Waste Disposal

Portable Trash and Waste Management Equipment

Waste Recycling/Reclamation Systems

Methane Synthesis to Liquid Fuels, Solvents, Industrial Products

Run-off Water Treatment

Petroleum Industry

Repressurization of Reservoirs to restore Oil Production—Avoids New Drilling

Reclamation of Water from Oil/Water Mix at Wellhead

Recovery of Carbon Dioxide for Ethanol Synthesis

Down Hole Hydrogenation of Petroleum Products

Reclamation of Drilling Mud Water

Enable Hydrocarbon Production from Oil Bearing Shales and Sands

Miscellaneous

Echo Ranging for Geological Structural Analysis

Extreme Depth Water Measurement

Sea Floor Mapping at Extreme Depth

Eliminate Gas Transportation Hazards—Point of Use Generation

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

### INDUSTRIAL APPLICABILITY

This invention may be industrially applied to devices and methods for generating alternative fuel sources, in particular, converting water into a viable alternative fuel source.

What is claimed:

1. An apparatus for generating a water vapor molecule with an unnatural bond angle comprising:
a. a voltage source of approximately 1 volt to approximately 500 volts providing current to create an intrinsic frequency;
b. a plurality of anode plates and a plurality of cathode plates in an alternating arrangement such that a gap of approximately 0.05 inch to approximately 1 inch exists between adjacent anode and cathode plates and each anode and cathode plate oriented to allow a flow of a water to pass in between each adjacent anode and cathode plate to create a resonating frequency of approximately 1 KHz to approximately 22 KHz;
c. a power pass through connecting the voltage source with the plurality of anode plates and the plurality of cathode plates to supply current to the plurality of anode plates and the plurality of cathode plates;
d. a water supply to provide the flow of the water across the plurality of anode plates and the plurality of cathode plates;
e. a chamber to contain the plurality anode plates, the plurality of cathode plates, and the water comprising
i. a first water inlet orifice,
ii. a second water inlet orifice opposite the first water inlet orifice,
f. a water pump to force the flow of water from the water supply into the chamber through the first water inlet orifice in a first direction and through the second water inlet orifice in a second direction, opposite the first direction, wherein the passage of the water across an electrically charged plate increases pressure in the chamber;
g. a water vapor trap located above the water, the water vapor trap comprising a water outlet orifice positioned on the water vapor trap for an overflowing water to be redirected back to the water supply;
h. a water vapor outlet positioned on the water vapor trap to allow the water vapor molecule with the unnatural bond angle to escape from the water vapor trap; and
i. a pressure vessel connected to the water vapor outlet to contain the water vapor molecule with the unnatural bond angle; wherein combining the intrinsic frequency and the resonating frequency created between the plurality of cathode plates and the plurality of anode plates converts the water molecule into the water vapor molecule with the unnatural bond angle for use as a fuel source.

2. An apparatus for generating a vapor molecule with an unnatural bond angle comprising:
a. a voltage source to provide a current;
b. a resistor-capacitor circuit comprising
i. an anode electrically connected to a negative terminal of the voltage source;
ii. a cathode, opposite the anode and electrically connected to a positive terminal of the voltage source; and
iii. a plurality of electrically conductive plates in between the anode and the cathode, each electrically conductive plate comprising a surface area and being separated by a gap;
c. a chamber to contain the anode, the cathode, the plurality of electrically conductive plates, and a fluid, wherein passing the current between the cathode and the anode generates a modifying frequency and increases a pressure in the chamber, thereby generating the vapor molecule with the unnatural bond angle.

3. The apparatus of claim 2, wherein
a. the voltage applied to the resistor-capacitor circuit comprises an intrinsic frequency; and
b. the plurality of electrically conductive plates generate a resonating frequency of approximately 50 Hz to approximately 40 KHz within the resistor-capacitor circuit, whereby the intrinsic frequency and the resonating frequency summate to generate the modifying frequency sufficient to modify a bond angle of the vapor molecule to an unnatural state.

4. The apparatus of claim 3, wherein the electrically conductive plates are substantially parallel to each other.

5. The apparatus of claim 4, wherein the gap is approximately 0.05 inch to approximately 1 inch.

6. The apparatus of claim 4, wherein the gap is approximately 0.05 inch to approximately 0.25 inch.

7. The apparatus of claim 4 further comprising a means for causing the fluid to flow substantially parallel along the electrically conductive plates to increase the efficiency of generating the vapor molecule with the unnatural bond angle.

8. The apparatus of claim 7, wherein the chamber comprises a first fluid inlet orifice through which the fluid can flow into the chamber and along the plurality of electrically conductive plates.

9. The apparatus of claim 8 further comprising
a. a fluid supply;
b. a fluid pump to force the flow of the fluid through the first fluid inlet orifice along the plurality of electrically conductive plates; and
c. a fluid outlet orifice to allow the fluid to recycle the fluid back to the fluid supply so as to allow a constant motion of flowing fluid across the plurality of electrically conductive plates.

10. The apparatus of claim 9 further comprising a second fluid inlet orifice positioned opposite the first fluid inlet orifice such that the fluid pump forces the fluid through the first fluid inlet orifice in a first direction while simultaneously forcing the fluid through the second fluid inlet orifice in a second direction opposite the first direction such that the fluid flows across the plurality of electrically conductive plates from at least two different directions to maximize a flow rate across the electrically conductive plates.

11. The apparatus of claim 9 further comprising:
a. a water vapor outlet; and
b. a pressure vessel connected to the water vapor outlet to contain the vapor molecule with the unnatural bond angle for storage until use.

12. A method of modifying a bond angle of a molecule comprising:
a. providing a first frequency;
b. providing a second frequency different from the first frequency;
c. generating a modifying frequency by combining the first frequency and the second frequency; and
d. exposing the molecule to the modifying frequency to create an unnatural bond angle.

13. The method of claim 12, further comprising the steps of
a. providing at least one additional frequency; and
b. combining the at least one additional frequency with the first and second frequency to generate the modifying frequency.

14. The method of claim 12, wherein
a. the first frequency is an intrinsic frequency generated by a power source;
b. the second frequency is a resonating frequency generated from a plurality of electrically conductive plates, wherein each electrically conductive plate comprises a surface area and is arranged parallel to each other; and
c. wherein the power source and the electrically conductive plates create a resistor-capacitor circuit.

15. The method of claim 14 further comprising:
a. pressurizing the molecule with the unnatural bond angle to maintain the unnatural bond angle; and
b. containing the pressurized molecule with the unnatural bond angle in a pressure vessel.

16. The method of claim 14, wherein the resonating frequency is approximately 50 Hz to approximately 40 KHz.

17. The method of claim 14, wherein the resonating frequency is approximately 1 KHz to approximately 22 KHz.

18. The method of claim 14 further comprising applying a current from the power source with a duty cycle of approximately 0.005 to approximately 0.50.

19. The method of claim 18, wherein the power source applied to the plurality of electrically conductive plates creates a power of at least approximately 10 watts per square feet of surface area.

20. The method of claim 19, wherein the power source applied to the plurality of electrically conductive plates creates a power of approximately 10 watts per square feet to approximately 100 watts per square feet of surface area.

21. The method of claim 20, wherein the power applied to the plurality of electrically conductive plates is approximately 30 watts per square feet of surface area to approximately 50 watts per square feet of surface area.

22. The method of claim 12 wherein the molecule is water.

23. A molecule comprising an unnatural bond angle wherein reversion of the unnatural bond angle back to a natural bond angle state releases energy.

24. The molecule of claim 23, wherein the molecule comprising the unnatural bond angle is pressurized.

25. The molecule of claim 24, wherein the molecule is water.

26. The molecule of claim 25, wherein the unnatural bond angle is greater than approximately 104.5 degrees.

27. The molecule of claim 26, wherein the unnatural bond angle is greater than approximately 109 degrees.

28. A method of using a molecule with an unnatural bond angle as an energy source comprising:
a. providing the molecule with the unnatural bond angle in a pressurized vessel at a pressure of approximately 1 psi to approximately 100 psi;
b. releasing the molecule with the unnatural bond angle from the pressurized vessel;
c. igniting the molecule with the unnatural bond angle,
d. wherein ignition of the molecule with the unnatural bond angle reverts the unnatural bond angle back to a natural bond angle state and releases energy.

29. The method of claim 28 further comprising using the energy as an alternative fuel source.

30. The method of claim 29, wherein the alternative fuel is used as a replacement for gasoline for powering a motorized device.

31. The method of claim 30, wherein the alternative fuel is used to maintain a flame.
